(19) United States
(12) Patent Application Publication
(10) Pub. No.: US 2006/0242074 A1
(43) Pub. Date: Oct. 26, 2006

(54) Encrypting digital rights management protected content

(75) Inventor: Heikki Kokkinen, Helsinki (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/122,277

(22) Filed: Apr. 22, 2005

(51) Int. Cl. H04L 9/00

(52) U.S. Cl. 705/53; 705/54

(57) ABSTRACT

The invention relates to a method, system and re-encryption module for handling protected content in a data communications network comprising a content server providing digital rights management protected content to a distributor. The method comprises re-encrypting digital rights management protected content provided by the content server with a distributor-specific key.

### BACKGROUND OF THE INVENTION

1. Field of the Invention

The invention relates to digital rights management. Particularly, the invention relates to handling protected content in a data communications network.

2. Description of the Related Art

Since the introduction of digital storage technologies more effective copyright enforcement has become an issue. Especially, the emergence of the Internet as an illicit distribution channel for copyright protected content has created a strong demand for new technologies in copyright protection. One such technology is the Digital Rights Management (DRM). The DRM is a common term for standards and proprietary systems where a given content item is augmented with information that specifies user rights associated with it. The content item may, for example, be an audio recording, video, picture, computer program or simply a document. The user rights may comprise various rules pertaining to the use of the content item. For example, a user may be given a time limit during which the content item can be presented, in other words, rendered to the user. Allowed number of listening times, allowed device identities and partial viewing rights are other examples of rules pertaining to the use of a content item. The DRM requires that the presentation device and the presentation software in it are not hostile, that is, they participate in the enforcement of digital rights. In the presentation device there is usually a DRM agent, or in other words, a DRM engine, which enforces the DRM rights and protects the content items from illicit copying. In order to avoid making a DRM protected content item available for copying, the content item may be encrypted while it is in transit from the network to the presentation device and while it is stored in the presentation device outside of the DRM engine, for example, on a hard disk.

One standard for the DRM is the one based on Open Mobile Alliance (OMA) DRM specifications. The aim of the OMA DRM is to enable controlled consumption of digital media objects by allowing content providers to express content rights. The media objects are content items such as audio clips, video clips, pictures, Java applications and documents. Content items governed by rights are referred to as assets. In the OMA DRM content rights are expressed as document objects, that is, documents written using a Rights Expression Language (REL). In order to specify the rights pertaining to an asset it is associated with a REL object. The association between a REL object and an asset may be specified explicitly by mentioning the asset's identifier in the REL object or implicitly by providing the REL object in a same message together with the asset.

OMA specification OMA-DRM-ARCHH-V2_{—}0-20040715-C discloses a method to deliver content more freely between individual users. The method is referred to as “Super Distribution”. In Super Distribution a given client who has downloaded content from a Content Issuer can in turn distribute this DRM Content to other devices using various networked links as well as removable media. This DRM Content is encrypted and is not usable by the receiving device/user until the associated rights are acquired for the content from a Rights Issuer. The device that receives this super-distributed content will discover the Rights Issuer URL within the DRM Content headers and use this information to connect to the Rights Issuer portal to acquire the rights.

FIG. 1 discloses a basic situation using the Super Distribution of OMA Specifications. FIG. 1 comprises a content provider 10, a distributor 12, a receiving device 14 and a rights manager 16. The distributor receives (100) some DRM Content from the content provider 10 and stores it locally. The distributor 12 wants to share this DRM Content with the receiving device 14, and as a result, transfers (102) this to the receiving device 14 using local connectivity or removable media. The receiving device 14, on reception of this DRM Content, discovers the Rights Issuer URL from the DRM Content headers and initiates a Rights Object Acquisition Protocol session with the Rights Manager 16 (104). On completion of this protocol and appropriate payment arrangements, the receiving device 14 obtains (106) the Rights Object associated with the requested DRM Content. Now, the user of the receiving device 14 is able to use this content.

In some situations it might be desirable to convey to the Rights Issuer also a piece of information identifying the party that delivered the protected content e.g. to a friend. The Super Distribution disclosed in the OMA specifications does not provide an answer to this need.

An obvious solution to this problem is to transfer a tag relating to the delivering party of the content from the friend to the Rights Issuer. Reference publication EP 1089241 discloses such a solution. A problem with this solution is that it is easy to change the tag and thus the delivered tag would refer to a wrong person. Furthermore, if the content is encrypted again with a seller identifier (tag), the existing digital rights management system needs to be changed quite a lot. If the digital rights management does not utilize the normal central digital rights management system, the content owner may have doubts on the reliability.

### SUMMARY OF THE INVENTION

According to one aspect of the invention there is provided a method of handling protected content in a data communications network comprising a content server providing digital rights management protected content to a distributor. The method comprises re-encrypting digital rights management protected content provided by the content server with a distributor-specific key.

In one embodiment of the invention, the method further comprises providing the content server with the distributor-specific key, re-encrypting the digital rights management protected content provided by the content server with the distributor-specific key in the content server, and sending the re-encrypted digital rights management protected content to the distributor. In one embodiment of the invention, the method further comprises delivering the re-encrypted digital rights management protected content to a receiving device, sending, from the receiving device, verification information to the distributor, and sending, from the distributor, in response to receiving the verification information from the receiving device a decryption key to decrypt the reencryption of the digital rights management protected content to the receiving device.

In one embodiment of the invention, the method further comprises providing, from the content server, digital rights management protected content to the distributor, and re-encrypting the digital rights management protected content provided by the content server with the distributor-specific key by the distributor. In one embodiment of the invention, the method further comprises delivering the re-encrypted digital rights management protected content to a receiving device, sending, from the receiving device, verification information to the distributor, and sending, from the distributor, in response to receiving the verification information from the receiving device a decryption key to decrypt the re-encryption of the digital rights management protected content to the receiving device.

According to another aspect of the invention there is provided a system of handling protected content in a data communications network. The system comprises a content server providing digital rights management protected content to a distributor, a distributor-specific key, and a re-encryption module configured to re-encrypt digital management rights protected content with the distributor-specific key.

In one embodiment of the invention, the distributor is configured to provide the content server with the distributor-specific key, the content server comprises the re-encryption module configured to re-encrypt the digital rights management protected content with the distributor-specific key, and the content server is configured to send the re-encrypted digital rights management protected content to the distributor. In one embodiment of the invention, the distributor is configured to deliver the re-encrypted digital rights management protected content to a receiving device, the receiving device is configured to send verification information to the distributor, and the distributor is configured to send in response to receiving the verification information from the receiving device a decryption key to decrypt the re-encryption of the digital rights management protected content to the receiving device.

In one embodiment of the invention, the content server is configured to provide digital rights management protected content to the distributor, and the distributor comprises the re-encryption module configured to re-encrypt the digital rights management protected content provided by the content server with the distributor-specific key. In one embodiment of the invention, the distributor is configured to deliver the re-encrypted digital rights management protected content to a receiving device, the receiving device is configured to send verification information to the distributor, and the distributor is configured to send in response to receiving the verification information from the receiving device a decryption key to decrypt the re-encryption of the digital rights management protected content to the receiving device.

According to another embodiment of the invention there is provided a re-encryption module in a data communications network. The re-encryption module comprises a distributor-specific key, and a re-encryption unit configured to re-encrypt digital management rights protected content with the distributor-specific key.

According to another embodiment of the invention there is provided a computer program embodied on a computer-readable medium to handle protected content, said program configured to perform the following steps when executed on a data-processing device: re-encrypting digital rights management protected content provided with a distributor-specific key.

An advantage of the invention compared to the existing DRM system is that the invention allows, for example, a network marketing business model. Transferring a tag only is simple, but it is easy to change the tag and therefore give the commission to a wrong account. If the content is encrypted again with a seller identifier, the existing DRM system needs to be changed quite a lot. However, if the seller can give the decrypting key for the exchange of the verification information from a receiving device, the digital rights management system may remain untouched. In other words, the invention can be used together with the existing DRM systems.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow diagram illustrating super distribution of digital rights management protected content in prior art;

FIG. 2a is a flow diagram illustrating a solution for re-encrypting digital rights management content according to one embodiment of the invention;

FIG. 2b is a flow diagram illustrating a solution for re-encrypting digital rights management content according to another embodiment of the invention;

FIG. 3a is a block diagram of a system according to one embodiment of the invention; and

FIG. 3b is a block diagram of a system according to another embodiment of the invention.

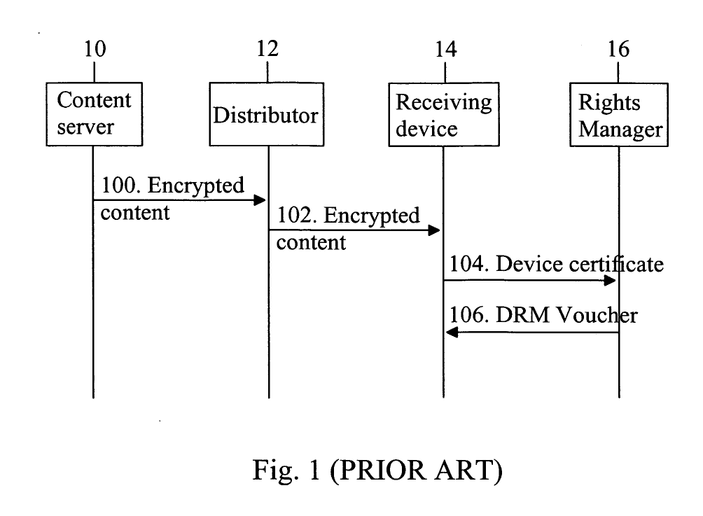

### DETAILED DESCRIPTION OF THE EMBODIMENTS

Reference will now be made in detail to the embodiments of the present invention, examples of which are illustrated in the accompanying drawings.

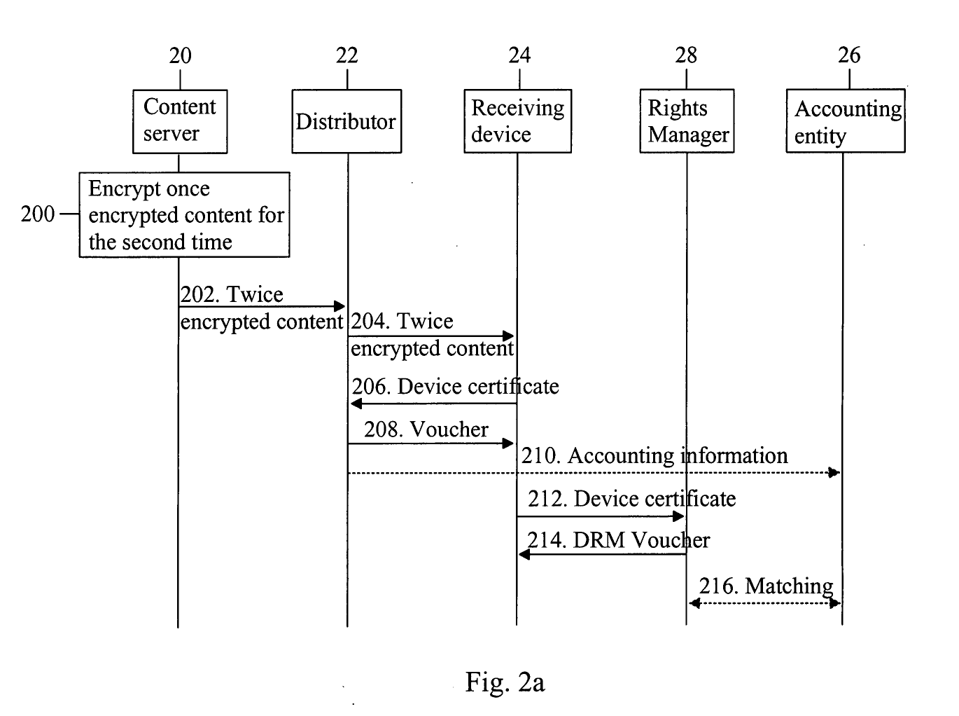

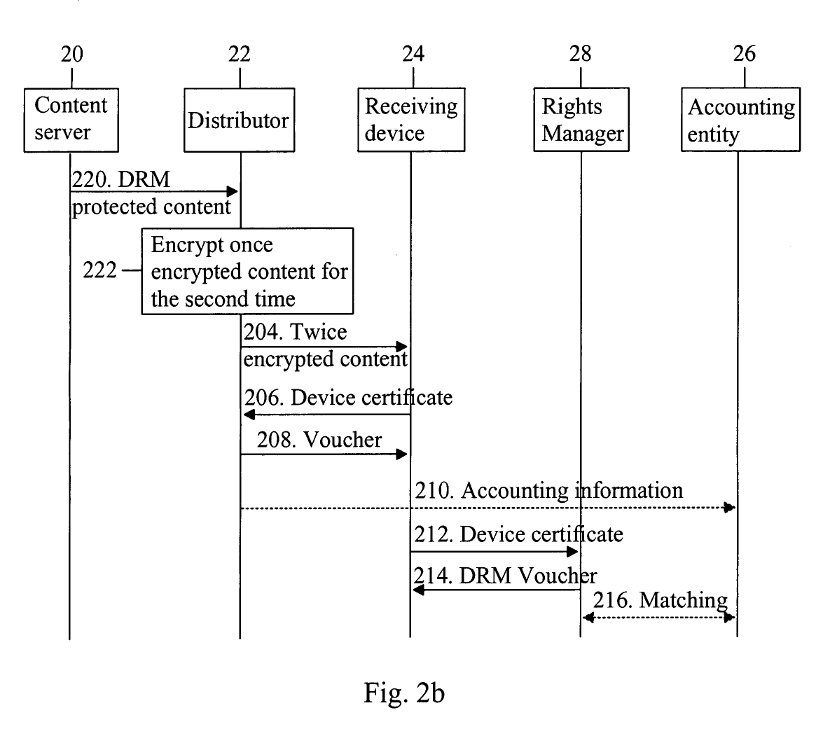

FIG. 2a discloses a solution for re-encrypting digital rights management content according to one embodiment of the invention. FIG. 2a comprises a content provider 20, a distributor 22, a receiving device 24 and a rights manager 26. The distributor 22 and receiving device 24 may refer to any applicable device, e.g. a computer, a personal digital assistant, a mobile terminal etc. In this example, digital rights management protected content is re-encrypted (200) in the content server 20. For the re-encryption process, the content server 20 comprises a distributor-specific key. In one embodiment, the distributor 22 provides the content server 20 with the distributor-specific key prior the re-encryption process. After the re-encryption process the content server 20 sends (202) the re-encrypted digital rights management protected content to the distributor 22.

The distributor 22 is free to deliver the re-encrypted digital rights management protected content to anyone wishing to receive it. For example, the distributor 22 may be an ordinary user that has earlier registered him/herself as a network-marketing distributor. He accesses the web interface of network marketing distributor account server. Furthermore, he selects a bunch of content, for example images and audio files. He downloads the content (which has already been re-encrypted in this example) to his mobile device and turns the network marketing software on before meeting his friends. The content he had downloaded from the web is visible to other network marketing users e.g. over the Bluetooth interface.

The re-encrypted digital rights management protected content is sent (204) to the receiving device 24. To be able to decrypt the re-encryption, the receiving device 24 needs a decryption key from the distributor 22. The receiving device 24 sends (206) verification information, e.g. a device certificate, to the distributor 22. In response to receiving the device certificate, the distributor 22 sends (208) a voucher (a decryption key) to the receiving device 24. Now the receiving device 24 is able to decrypt the re-encryption.

The receiving device 24, on reception of the DRM Content, discovers the rights manager URL from the DRM Content headers and initiates (212) a Rights Object Acquisition Protocol session with the rights manager 26. On completion of this protocol and appropriate payment arrangements, the receiving device 24 obtains (214) the Rights Object associated with DRM Content. Now, the user of the receiving device 24 is able to use this content.

Each time somebody downloads content from distributor, he may be provided with a commission from the network marketing service provider. After receiving the device certificate from the receiving device 24, the distributor 22 sends (210) accounting information to an accounting entity 26. The accounting information defines, for example, who has downloaded content from the distributor and what was the downloaded content. Based on the accounting information the accounting entity 26 compares (216) the accounting information from the distributor 22 to the DRM transactions of the receiving device 24, and if they match, the accounting entity 26 gives a commission to the distributor 22.

FIG. 2b discloses a solution for re-encrypting digital rights management content according to another embodiment of the invention. The solution disclosed in FIG. 2b is almost the same as the one in FIG. 2a. The difference between FIGS. 2a and 2b is that in FIG. 2b the distributor 22 performs the re-encryption process (222) of digital rights management protected content. Therefore, the content server 20 provides (220) the distributor 22 with digital right management protected content in a normal way.

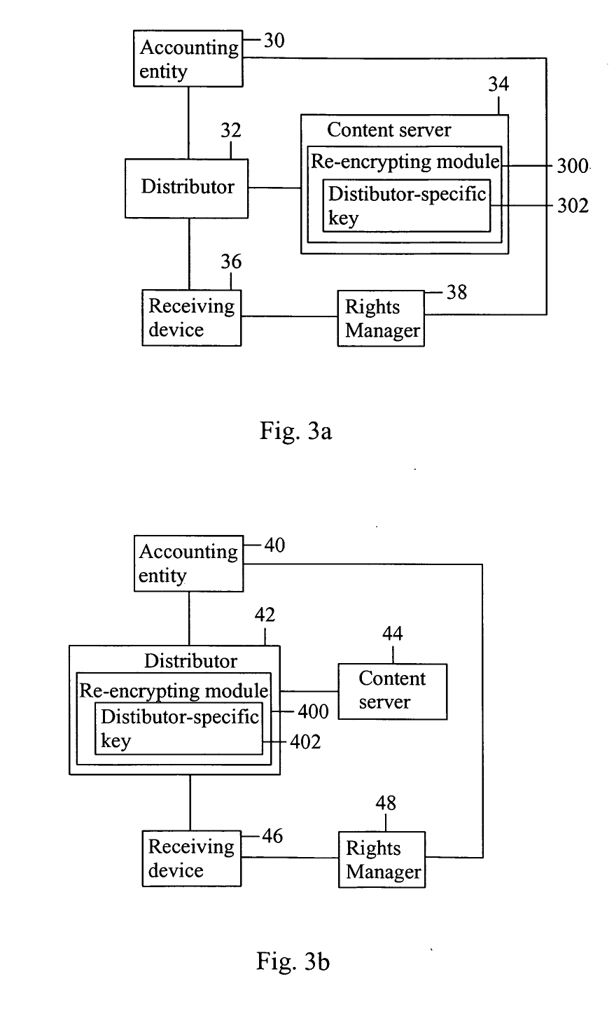

FIG. 3a discloses a block diagram of a system according to one embodiment of the invention. The system comprises a distributor 32 connected to a content server 34. The content server 34 provides digital rights management protected content to devices requesting the content. The distributor 32 is also connected to a receiving device 36 and to an accounting entity 30. The receiving device 38 is connected to a rights manager 38 that provides rights objects for digital rights management protected content. The accounting entity 30 is also connected to the rights manager 38. In this embodiment, the content server 34 comprises a re-encrypting module 300 that re-encrypts digital rights management protected content with a distributor-specific key 302. Functional operation of elements of FIG. 3a is disclosed in FIG. 2a.

FIG. 3b discloses a block diagram of a system according to one embodiment of the invention. The system comprises a distributor 42 connected to a content server 44. The content server 44 provides digital rights management protected content to devices requesting the content. The distributor 42 is also connected to a receiving device 46 and to an accounting entity 40. The receiving device 48 is connected to a rights manager 48 that provides rights objects for digital rights management protected content. The accounting entity 40 is also connected to the rights manager 48. In this embodiment, the distributor 42 comprises a re-encrypting module 400 that re-encrypts digital rights management protected content with a distributor-specific key 402. Functional operation of elements of FIG. 3b is disclosed in FIG. 2b.

The re-encrypting module 300, 400 refers e.g. to a processing unit or to a combination of a processing unit and a memory. The memory may also include a computer program (or portion thereof), which when executed on the processing unit performs at least some of the steps of the invention. The processing unit may also include memory or a memory may be associated therewith which may include the computer program (or portion thereof) which when executed on the processing unit performs at least some of the steps of the invention.

Furthermore, in FIGS. 3a and 3b each of the receiving device, distributor and content server comprises means for processing information, means for sending information to other devices and means for receiving information from other devices. The aforementioned means may refer to at least one of the hardware units (e.g. to a processor, memory etc.) or software stored on a memory.

It is obvious to a person skilled in the art that with the advancement of technology, the basic idea of the invention may be implemented in various ways. The invention and its embodiments are thus not limited to the examples described above; instead they may vary within the scope of the claims.

What is claimed is:

1. A method of handling protected content in a data communications network comprising a content server providing digital rights management protected content to a distributor, the method comprising:
re-encrypting digital rights management protected content provided by the content server with a distributor-specific key.

2. The method according to claim 1, further comprising:
providing the content server with the distributor-specific key;
re-encrypting the digital rights management protected content provided by the content server with the distributor-specific key in the content server; and
sending the re-encrypted digital rights management protected content to the distributor.

3. The method according to claim 2, further comprising:
delivering the re-encrypted digital rights management protected content to a receiving device;
sending, from the receiving device, verification information to the distributor; and
sending, from the distributor, in response to receiving the verification information from the receiving device a decryption key to decrypt the re-encryption of the digital rights management protected content to the receiving device.

4. The method according to claim 3, further comprising:
sending, from the distributor, at least part of the verification information and information identifying the delivered content to an accounting entity.

5. The method according to claim 3, wherein the verification information comprises a device certificate.

6. The method according to claim 1, further comprising:
providing, from the content server, digital rights management protected content to the distributor; and
re-encrypting the digital rights management protected content provided by the content server with the distributor-specific key by the distributor.

7. The method according to claim 6, further comprising:
delivering the re-encrypted digital rights management protected content to a receiving device;
sending, from the receiving device, verification information to the distributor; and
sending, from the distributor, in response to receiving the verification information from the receiving device a decryption key to decrypt the re-encryption of the digital rights management protected content to the receiving device.

8. The method according to claim 7, further comprising:
sending, from the distributor, at least part of the verification information and information identifying the delivered content to an accounting entity.

9. The method according to claim 7, wherein the verification information comprises a device certificate.

10. A system of handling protected content in a data communications network, the system comprising:
a content server providing digital rights management protected content to a distributor;
a distributor-specific key; and
a re-encryption module configured to re-encrypt digital management rights protected content with the distributor-specific key.

11. The system according to claim 10, wherein:
the distributor is configured to provide the content server with the distributor-specific key;
the content server comprises the re-encryption module configured to re-encrypt the digital rights management protected content with the distributor-specific key; and
the content server is configured to send the re-encrypted digital rights management protected content to the distributor.

12. The system according to claim 11, wherein:
the distributor is configured to deliver the re-encrypted digital rights management protected content to a receiving device;
the receiving device is configured to send verification information to the distributor; and
the distributor is configured to send in response to receiving the verification information from the receiving device a decryption key to decrypt the re-encryption of the digital rights management protected content to the receiving device.

13. The system according to claim 11, wherein:
the distributor is configured to send at least part of the verification information and information identifying the delivered content to an accounting entity.

14. The system according to claim 11, wherein the verification information comprises a device certificate.

15. The system according to claim 10, wherein:
the content server is configured to provide digital rights management protected content to the distributor; and
the distributor comprises the re-encryption module configured to re-encrypt the digital rights management protected content provided by the content server with the distributor-specific key.

16. The system according to claim 15, wherein:
the distributor is configured to deliver the re-encrypted digital rights management protected content to a receiving device;
the receiving device is configured to send verification information to the distributor; and
the distributor is configured to send in response to receiving the verification information from the receiving device a decryption key to decrypt the re-encryption of the digital rights management protected content to the receiving device.

17. The system according to claim 16, wherein:
the distributor is configured to send at least part of the verification information and information identifying the delivered content to an accounting entity.

18. The system according to claim 16, wherein the verification information comprises a device certificate.

19. A re-encryption module in a data communications network, comprising:
a distributor-specific key; and
a re-encryption unit configured to re-encrypt digital management rights protected content with the distributor-specific key.

20. A computer program embodied on a computer-readable medium to handle protected content, said program configured to perform the following steps when executed on a data-processing device:
re-encrypting digital rights management protected content provided with a distributor-specific key.
